(19) United States
(12) Patent Application Publication
(10) Pub. No.: US 2018/0067779 A1
(43) Pub. Date: Mar. 8, 2018

(54) AP-Based Intelligent Fog Agent

(71) Applicant: Smartiply, Inc., Basking Ridge, NJ (US)

(72) Inventors: Raghuram Kaushik Pillalamarri, Basking Ridge, NJ (US); Junshan Zhang, Tempe, AZ (US); Shunge Li, Duluth, GA (US); Arsalan A. Gilani, Teaneck, NJ (US); Ratan Bajpai, Mount Laurel, NJ (US)

(21) Appl. No.: 15/695,774

(22) Filed: Sep. 5, 2017

Related U.S. Application Data
(60) Provisional application No. 62/384,116, filed on Sep. 6, 2016.

(51) Int. Cl. G06F 9/50; H04L 29/08

(52) U.S. Cl. CPC G06F 9/5072; H04L 67/10

(57) ABSTRACT

An AP based intelligent fog agent, for example based on a WiFi AP, manages fog computing using WiFi, WiFi Direct, or a similar system, to connect IoT devices and enhance interoperability. The fog agent, using data analytics modules, provides edge intelligence and permits a substantial amount of computing, including network measurement, graphics processing, actuation, and control, to occur within one or two hops from the end-user. Forming proximity-based fog networks leads to hierarchical network management and strengthens security and privacy protections. P2P communications, such as messaging and content sharing, among connected devices is also facilitated connecting to it. Real-time cyber-physical system control, real-time security intelligence, content distribution and media sharing, can all benefit from the new fog agent.

### RELATED APPLICATIONS

This application claims the benefit of U.S. Provisional Patent Application No. 62/384,116 filed on Sep. 6, 2016.

### FIELD

The present disclosure relates to the Internet of Things (IoT). More specifically, and not by any way of limitation, this invention relates to fog computing networks.

### BACKGROUND

The Internet of Things (IoT) is the network of physical objects, devices, or things embedded with electronics, software, sensors, and network connectivity, which enables these things to exchange data, collaborate, and share resources. 2015 was the year IoT gained widespread attention, and companies across many industries put IoT squarely in their sights.

The past few years have witnessed a rapid growth of mobile and IoT applications, and computation-intensive applications for interactive gaming, augmented reality, virtual reality, image processing and recognition, artificial intelligence, and real-time data analytics applications. These applications are resource-hungry and require intensive computing power and fast or real-time response times. Due to the nature of their application domain and physical size constraints, many IoT devices (e.g., mobile phones, wearable devices, connected vehicles, augmented reality devices, sensors, and appliances) are computing resource-constrained, thus giving rise to significant challenges for next generation mobile and IoT application development.

Fog computing or fog networking, also known as fogging, is an architecture that uses one or a collaborative multitude of end-user clients or near-user edge devices to carry out a substantial amount of storage (rather than stored primarily in cloud data centers), communication (rather than routed over the internet backbone), and control, configuration, measurement and management (rather than controlled primarily by network gateways such as those in the LTE core). Fog networking supports the IoT, in which many of the devices used by consumers on a daily basis will be connected with each other.

### BRIEF DESCRIPTION OF THE DRAWINGS

For a more complete understanding of the present invention, reference is now made to the following descriptions taken in conjunction with the accompanying drawings, in which:

FIG. 1 illustrates an embodiment of a fog network;

FIG. 2 illustrates an embodiment of an AP based intelligent fog agent;

FIG. 3 illustrates another embodiment of a fog network;

FIG. 4 illustrates a method of operating an embodiment of a fog network;

FIG. 5 illustrates another embodiment of a fog network;

FIG. 6 illustrates another method of operating an embodiment of a fog network;

FIG. 7 illustrates a tier structure of an embodiment of a fog network; and

FIG. 8 illustrates another embodiment of an AP based intelligent fog agent.

### DETAILED DESCRIPTION

The past four decades have witnessed three computing revolutions: The PC revolution, the internet revolution, and the mobile revolution. Fog computing may be the next. Fog computing is still at its infancy stage; some companies are developing APIs and middleware services to be deployed on hardware devices so that these devices can be customized for various industry needs. Such devices, properly configured, are often termed “fog nodes.” With a properly-implemented system, services that are currently available on a traditional remote cloud node, such as software, platform, and infrastructure, will be possible on local fog nodes. A WiFi access point (AP) based intelligent fog agent will be the enabling technology. A local fog node is a node that is local to the fog agent and within the fog network that is managed by the fog agent.

A WiFi AP is a wireless access point that is widely used as networking hardware device to allow multiple WiFi compliant devices to connect to a wired network. Modern WiFi APs are built to support a standard for sending and receiving data using radio frequencies, for example one of the IEEE 802.11 standards. Current WiFi APs offer network connectivity only, with no computing power and mass storage.

Wireless networking has emerged as one of main connectivity means for IoT applications, e.g., within smart home-buildings and smart manufacturing facilities. Data generated locally is increasingly analyzed and consumed locally, which is a manifestation of fog computing. Thus, there is a need to enable real-time data analytics and cyber physical network actuation and control functions within stringent temporal constraints. This is particularly essential for Tactile IoT applications. Fundamentally, it boils down to what kind of intelligence can be accomplished on the network edge, particularly at a wireless hub or gateway where computing, communication and storage resources can be made available at low cost.

To meet these needs, a WiFi AP based intelligent fog agent offers edge intelligence in IoT applications, so that it can carry out a substantial amount of computing (such as data analytics, artificial intelligence (AI), and machine learning); offer a substantial amount of storage for messaging, content distribution, and media sharing; and carry out a substantial amount of real-time communication over WiFi or a similar network. The following technologies will play a key role in IoT applications: (a) network connectivity enables a fully mobile and connected world in the IoT ecosystem; (b) fog computing offers real-time processing and intelligence at the network edge; and (c) interoperability between various IoT devices is critically important to capture maximum economic value.

Designed to offer edge intelligence in IoT applications, and in particular to enable real-time data analytics and cyber physical network's actuation and control functions under ultra-low latency, a WiFi AP based intelligent fog agent will be capable of multiple functions. These include (a) using WiFi or a similar system (e.g., WiFi Direct) as a common network to connect heterogeneous IoT devices and to enhance interoperability; (b) using built-in data analytics application programming interface (API) modules to offer the edge intelligence in a fog environment; (c) carrying out a substantial amount of computing, including network measurement, graphics processing, actuation, and control, within one or two hops from the end-user; (d) offering a substantial amount of storage within one or two hops from the end-user; (e) carrying out a substantial amount of communication within one or two hops from the end-user; (f) forming proximity-based fog networks, which naturally lead to hierarchical network management and strengthen security and privacy protection; (g) facilitating peer-to-peer communications, such as messaging and content sharing, among WiFi enabled devices connecting to it; (h) interoperating with nearby routers of the same capability to enable wider reach of the fog network; and (i) providing domain-specific information services, information search, and value added services enabled by AI and machine learning.

With the above innovative capabilities, an AP based intelligent fog agent will support a variety of emerging IoT applications and services in many vertical services and horizontal markets, including smart factories, smart cities, smart homes, retail stores, cruise lines, airlines, vehicular telematics, healthcare, green information and communication technologies (ICT), industrial internet, industry monitoring, and others. Although an AP based intelligent fog agent may use WiFi as the communication method, other systems may also be used. An AP based intelligent fog agent will provide computing power and reams of information to offer IoT solutions that collect data from sensors, appliances and machines, and use data analytics and machine learning to identify inefficiencies and offer operational actions for improvement, much in the same way that the smartphone puts computing power and reams of information into pockets.

In the same spirit as the cell phone was transformed into the smartphone, an intelligent fog agent transforms a mere AP into an intelligent node with computing, communication, and storage capabilities, enabled by cutting-edge AI technology. The same transformation will carry over to small cells deployed in cellular networks. Simpler APs will be replaced by AP based intelligent fog agents with a variety of intelligence levels that are tailored towards specific IoT applications, and are equipped with computing intelligence, mass storage, and WiFi-enabled (or other system) communication capability. Built on a WiFi AP (or other communication system AP), the intelligent fog agent will have computing intelligence, storage, sensing functionalities. For example, a WiFi AP based intelligent fog agent will be capable of local computing and network management, including data analytics and graphics processing. Further, it can (a) serve code offloading from smart devices to proximity devices, (b) offer content distribution and media sharing, (c) support AP-to-AP communication in a peer to peer fashion, and (d) enable messaging between WiFi-enabled devices that it serves by acting as a messaging gateway.

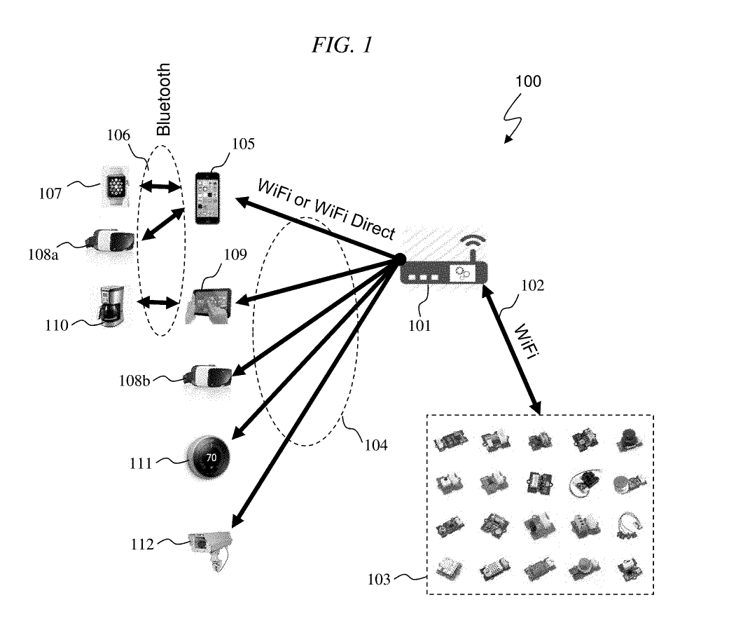

Turning now to the Figures, FIG. 1 illustrates an embodiment of a fog network 100. Fog network 100 is comprised of an AP based intelligent fog agent 101, which communicates over a WiFi wireless pathway 102 to a set 103 of WiFi-capable devices. In this illustrated embodiment, AP based intelligent fog agent 101 is a WiFi AP based intelligent fog agent, although different communications systems, other than WiFi, may also be used in other embodiments of fog network 100.

Fog agent 101 also communicates over a WiFi Direct wireless pathway 104 to a set of WiFi Direct-capable devices, although these devices may also be WiFi-only, rather than WiFi Direct-capable. This set of devices includes a smartphone 105 that communicates over a Bluetooth wireless pathway 106 with wearable devices. These wearable devices include a smartwatch 107 and a 3-D goggle device 108a. Another one of the WiFi Direct-capable devices is tablet 109, which also communicates over Bluetooth wireless pathway 106 with appliance 110. As illustrated, appliance 110 is a coffee maker, although tablet 109 could communicate with other types of appliances. Additional ones of the illustrated the WiFi Direct-capable devices include another 3-D goggle device 108b (which is WiFi or WiFi Direct capable), a smart thermostat 111, and a security camera 112. It should be noted that many other devices may also be part of a fog network.

Thus, fog network 100 includes a variety of IoT devices (103, 105, and 107-112. In general, IoT devices are connected to one another through wired or wireless networks such as using short-range communications (e.g., WiFi, WiFi Direct, ZigBee, Bluetooth, and Ethernet communications). Whether operating according to traditional modes or as part of a fog network, IoT devices may operate in client-server or peer-to-peer configurations.

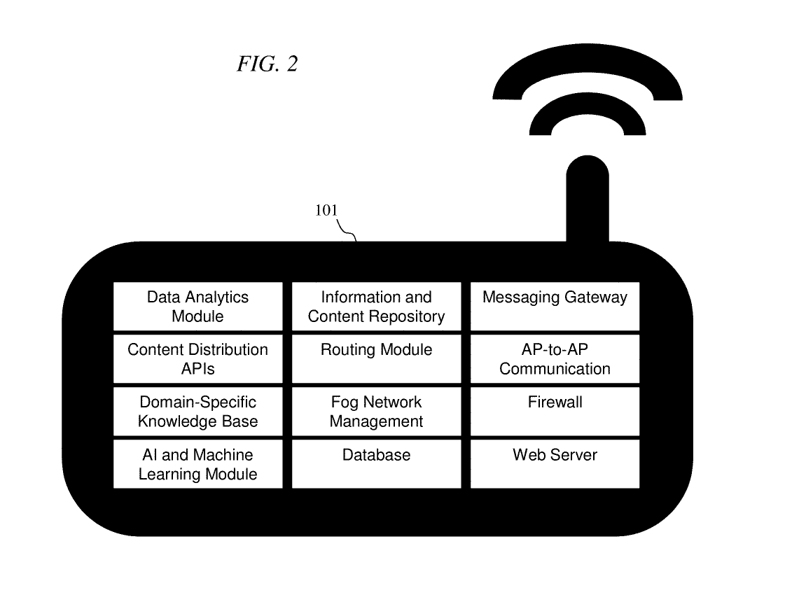

FIG. 2 illustrates a more detailed view of an embodiment of AP based intelligent fog agent 101. Fog agent 101 is configured to operate as a WiFi fog hub, to meet specific requirements of IoT applications. As depicted in FIG. 2, some embodiments of fog agent 101 may be built on top of a standard AP hardware platform, which typically consists of local area network (LAN) and wide area network (WAN) interfaces (wired or wireless) and RF modules. The LAN may be WiFi, although other LAN systems may be used. The WAN may be wired, cellular (such as LTE) or some other system. The embodiment of FIG. 2 shows multiple logic modules, which can be configured to be executable by a processor, and stored on non-transitory media. The logic modules illustrated include data analytics information and content repository, messaging gateway, content distribution APIs, routing, AP-to-AP communication (which may operate as a peer-to-peer (P2P) module), domain-specific knowledge base, fog network management, firewall, AI and machine learning, database, and web server. These logic modules may comprise software, firmware, FPGAs, ASICs, or any combination. One possible implementation approach can be based on a combination of a traditional WiFi AP design and a personal computer (PC) engine, which may have customized computing power and storage capabilities.

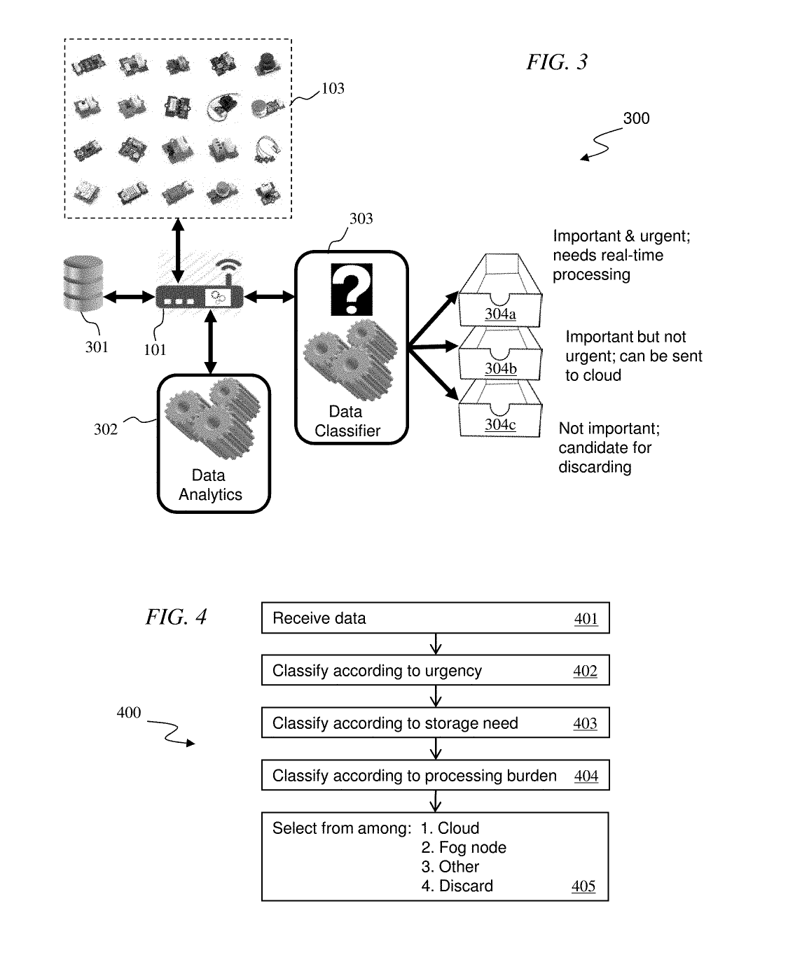

FIG. 3 illustrates an embodiment of a fog network 300, specially adapted to computing tasks. Fog network 300 may be similar in construction and operation to fog network 100 of FIG. 1, or may have a different configuration. Fog network 300 comprises set 103 of WiFi-capable devices (a.k.a. IoT devices), in this configuration. Fog network 300 additionally comprises and embodiment of fog agent 101. A storage unit 301 is connected to fog agent 101, as is a data analytics engine 302. Although storage unit 301 and data analytics engine 302 are illustrated as outside fog agent 101, some embodiments of fog agent 101 may contain all or parts of storage unit 301 and data analytics engine 302. That is, fog agent 101 may have internal storage that is optionally supplemented by external storage. Additionally, fog agent 101 may have internal computing hardware and software that is needed to provide the functionality of data analytics engine 302, although the functionality may be supplemented by a nearby connected second computing device. These configurations permit a substantial amount of information to be performed in the immediate vicinity of fog agent 101, perhaps one or two hops away—or even entirely within fog agent 101.

A data classifier 303 is also illustrated as externally-connected to fog agent 101, although this functionality may also be fully or partially within fog agent 101, as described above for storage unit 301 and data analytics engine 302, or may be a portion of data analytics engine 302. Data classifier 303 analyzes data on the fog network and may be a PC or other suitable computing device, including computational capability residing within fog agent 101. It should be noted that any of storage unit 301, data analytics engine 302, and data classifier 303 may be directly coupled with each other.

Data classifier 303 performs a significant role within fog network 300. Pushing (or sending) data up to the remote cloud nodes for processing may introduce a delay, due to unpredictable latency in communications. Some data may have sufficient urgency that the latency associated with cloud computing is undesirable. So, to improve performance, data classifier 303 sorts data into various categories. One category may be important and urgent data, which needs real-time processing. This is indicated as box 304a, coupled to data classifier 303. Such data may be retained within fog network 300 for processing within one or two hops of fog agent 101, to minimize communication latencies.

Another category may be important data that is not urgent, which can be stored locally, but which can also be pushed up into the cloud for processing, when WiFi connections are available (so as to avoid the cost associated with cellular data usage). This is illustrated in FIG. 3 as box 304b. Yet another possible category, illustrated as box 304c, may be unimportant data that is a candidate for discarding. This is only an exemplary set; a myriad of other possible categorizations exist, such as data which requires so much processing power that local resources are insufficient, so that cloud resources are required. Local resources are those that are within the fog network that is managed by the fog agent. Another possibility is that the storage requirements are so burdensome that the data must be sent to a large repository elsewhere. Additionally, older data may be archived elsewhere, so data classifier 303 may consider age of the data when deciding where to store it. Also, many organizations use off-site storage for back-ups, as an information assurance measure, so data classifier 303, working with data analytics engine 302, may ascertain which data stored within storage unit 301 requires back-up, and whether off-site back-up has been specified for that data. Thus, data classifier 303 and data analytics engine 302 may work in conjunction to analyze whether data that is stored locally may require off-site (i.e., remote cloud node) archival or duplicated back-up. Such a determination may be made based upon the age and importance of the data.

FIG. 4 illustrates a method 400 of operating fog network 300, and is described in relation to the components illustrated in FIG. 3. Method 400 begins in block 401, when data is received from a IoT device (i.e., any of IoT devices 103, 105, and 107-112), perhaps by fog agent 101. Data classifier 303 classifies the data according to urgency in block 402, and also by storage need in block 403. Additional classification may include processing burden categorization, as shown in block 404. With these classifications thus performed, a forwarding action is selected in block 405. The illustrated options include (1) cloud; (2) fog node; (3) other action; and (4) discard. If a fog node is selected, an additional selection may be made by any of fog agent 101, data analytics engine 302, and data classifier 303. Other actions may include temporary local storage and forwarding at a later time, or dividing among both fog nodes and cloud resources. It should be noted that not all steps of method 400 may be performed each time data is received, and that other methods are also possible with fog network 300.

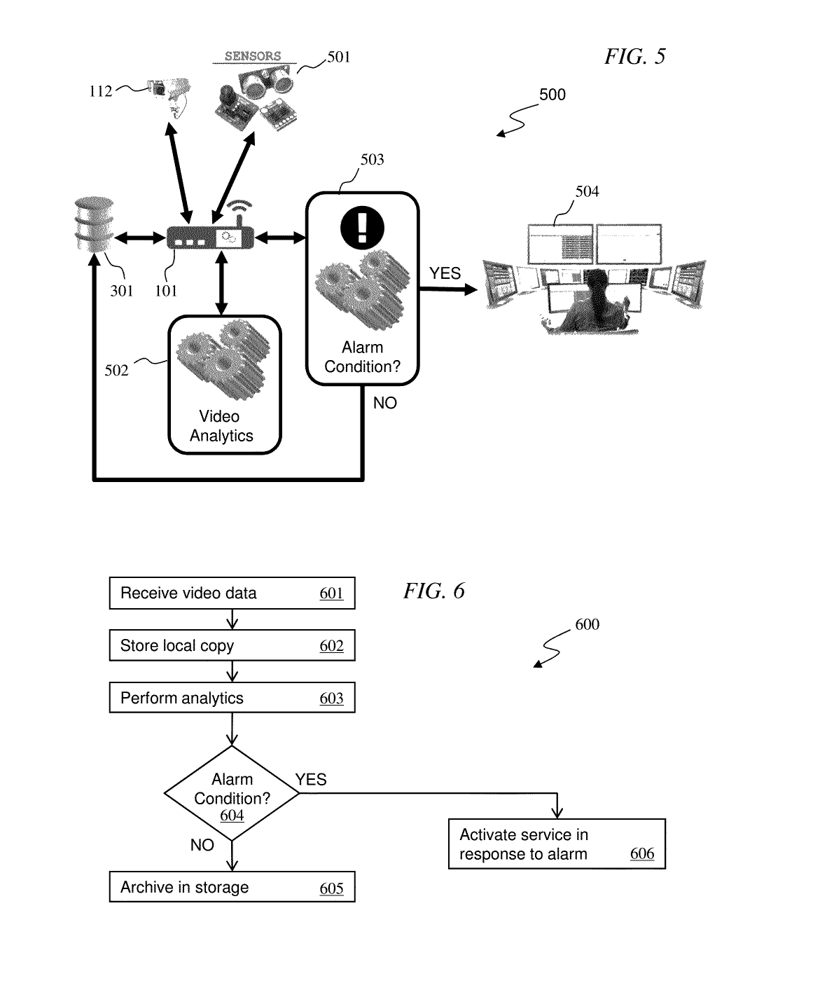

FIG. 5 illustrates an embodiment of a fog network 500, specially adapted to video-related tasks, such as security monitor. Fog network 500 may be similar in construction and operation to fog network 100 of FIG. 1, or may have a different configuration. Fog network 500 comprises security camera 112 and a set of other sensors 501, which may include intrusion, smoke, audio, moisture, and temperature sensors. Security camera 112 and sensors 501 are example IoT devices, in this configuration. Fog network 500 additionally comprises and embodiment of fog agent 101 and is connected to storage unit 301. A video analytics engine 502 is connected to fog agent 101, as is also an alarm condition processor 503.

Although video analytics engine 502 is illustrated as outside fog agent 101, some embodiments of fog agent 101 may contain all or parts of video analytics engine 502. That is, fog agent 101 may have internal computing hardware and software that is needed to provide the functionality of video analytics engine 502, although the functionality may be supplemented by a nearby connected second computing device. These configurations permit a substantial amount of information to be performed in the immediate vicinity of fog agent 101, perhaps one or two hops away—or even entirely within fog agent 101.

Alarm condition processor 503 is also illustrated as externally-connected to fog agent 101, although this functionality may also be fully or partially within fog agent 101, as described above for storage unit 301 and video analytics engine 502. Alarm condition processor 503 may be a PC or other suitable computing device, including computational capability residing within fog agent 101. Also, it should be noted that any of storage unit 301, video analytics engine 502, and alarm condition processor 503 may be directly coupled with each other.

Alarm condition processor 503 performs a significant role within fog network 500. To minimize data overload on security monitors, alarm condition processor 503 selects which data is passed along to a monitoring center 504 that is connected to fog network 500 or trigger an alarm to send to monitoring center 504. One possible criteria is whether the local processing in the vicinity of fog agent 101 (i.e., within one or two hops) has indicated an alarm condition. If this is the condition used, then a NO result may dictate only local storage (or possible cloud archiving of the video data, if fog network 500 is combined with fog network 300 of FIG. 3) in storage unit 301. A YES result on an alarm condition, such as for example an analysis of the video stream from security camera 112 detecting a human intruder, would activate an alarm and call for assistance from monitoring center 504.

For example, video analytics engine 502 may detect a human intruder, causing alarm condition processor 503 to send an alert to monitoring center 504 in this manner: Video analytics engine 502 receives a video stream from security camera 112 and compresses subsequent image frames from a particular scene by storing an initial frame and then frame-to-frame differences. If nothing changes from frame to frame, the compression output will be small. If a human intruder walks into the scene, the image frames in the video stream will have sufficient differences that he compressed stream will become larger. A threshold on the frame-to-frame difference can trigger a machine vision algorithm, which may trigger the alarm condition. For example, an image frame may be subjected to a face detection process, or other process, to detect whether an alarm condition is warranted.

FIG. 6 illustrates a method 600 of operating fog network 500, and is described in relation to the components illustrated in FIG. 5. Method 600 begins in block 601, when video data is received from security camera 112 or sensors 501, perhaps by fog agent 101. A local copy is stored in block 602, and analytics are performed by video analytics engine 502, in block 603. In decision block 604, alarm condition processor 503 decides whether to issue an alert or alarm condition. If NO, then the video data is stored locally, according to block 605, perhaps in storage unit 301 and maybe later archived in a cloud resource. If YES, then an alert or alarm is sent to monitoring center 504, according to block 606.

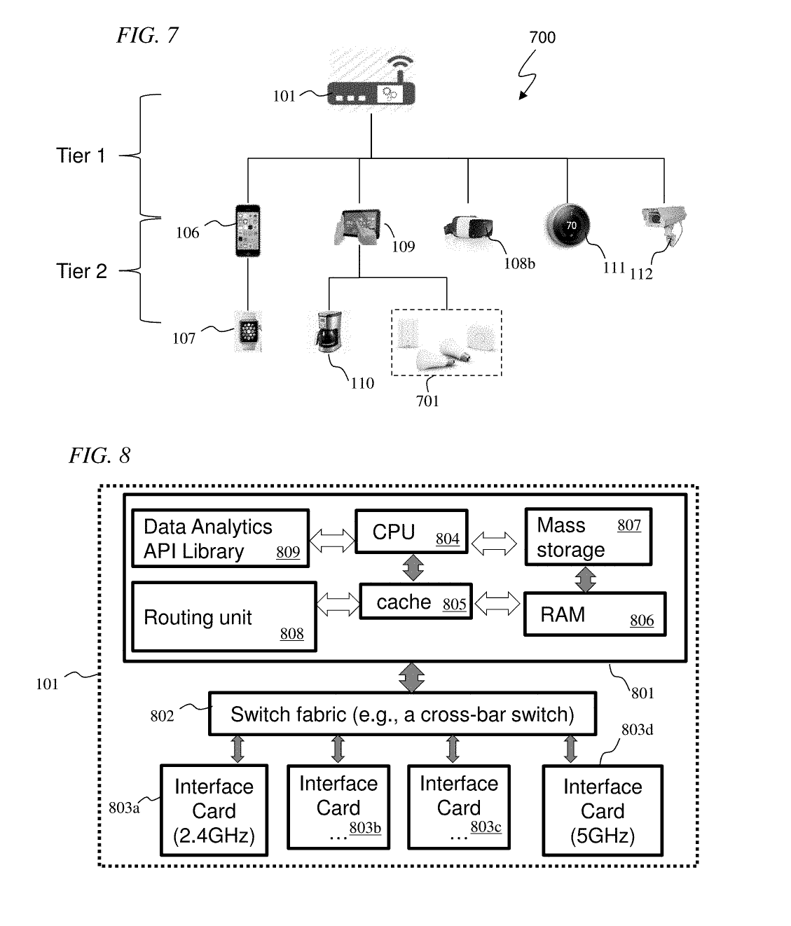

FIG. 7 illustrates a tier structure of an embodiment of a fog network 700, which may be any of fog network 100, fog network 300, and fog network 500. Tier 1 is the hierarchical relationship in which fog agent 101 acts as a fog network manager, and the first layer fog nodes includes smartphone 105, tablet 109, 3-D goggles device 108b, smart thermostat 111, and security camera 112. This first tier, Tier 1, may use WiFi, WiFi Direct, or another communication system. Other IoT devices, acting as fog nodes, may also be part of Tier 1.

Tier 2, which is the second tier, is defined by a fog node managing edge devices, for example managing security and privacy functions. Tier 2 may use Bluetooth, although other communication systems may also be used. As illustrated, the edge nodes include smartwatch 107 (coupled to smartphone 105), and appliance 110 and a smart lighting 701 system (both coupled to tablet 109). Other IoT devices, acting as edge devices, may also be part of Tier 2.

FIG. 8 illustrates another perspective of an embodiment of AP based intelligent fog agent 101. Whereas FIG. 2 illustrated logical functionality of fog agent 101, FIG. 8 illustrates included components. As depicted in FIG. 8, some embodiments of fog agent 101 may be built on top of a standard AP hardware platform, which typically comprises a computing functionality 801, which is coupled to a switch 802, that is further connected to multiple interface cards (803a-803d). These include a 2.4 GHz card 803a, two additional interface cards, which may be wired or a different wireless system, and 5 GHz interface card 803d. WiFi uses both 2.4 GHz and 5 GHz frequencies, so interface cards 803a and 803d may be WiFi interfaces. Interface cards 803a-803d may include both LAN and WAN interfaces (either wired or wireless), radio frequency (RF) modules, and universal serial bus (USB) ports.

Computing functionality 801 comprises a CPU 804, a cache 805, a memory (RAM) 806, a mass storage 807, a routing unit 808, and a Data Analytics API Library 809. Memory 806 and mass storage 807 are non-transitory computer-readable media that are suitable for storing executable program instructions that are executable by CPU (processor) 804. Mass storage 807 may be a manifestation of storage unit 301 (of FIGS. 3 and 5), or comprise a portion of storage unit 301. Data Analytics API Library 809 may include some or all of the functionality of data analytics engine 302, data classifier 303, working with data analytics engine 302video analytics engine 502, and alarm condition processor 503. Data Analytics API Library 809 may be stored in one or both of memory 806 and mass storage 807. The list of logic modules indicated in FIG. 2 may also be stored in one or both of memory 806 and mass storage 807. In general, memory 806 and mass storage 807 may comprise both readable/writeable and read-only portions, and may also collectively be referred to as memory.

The systems and methods thus described have multiple applications. These include (a) real-time cyber-physical system control; (b) real-time security intelligence; (c) content distribution and media sharing; (d) P2P messaging and group messaging; (e) providing value-added services.

(a) AP based intelligent fog agent for real-time cyber-physical system control. By integrating communications, storage, and computing capabilities into an intelligent AP based fog agent, allows IoT real-time data analytics to run directly on the fog agent for real-time data collection, storage, and analysis at the network edge. This kind of edge intelligence can transform data into time-critical action for cyber-physical actuation and control under stringent time constraints. In particular, a library of APIs for data analytics can be built into an AP based fog agent, aiming to offer IoT and business analytics capabilities throughout enterprise deployments. Powered by AI, voice-activated control functions can also be built into the fog agent for mobile-to-mobile (M2M) communication and control in cyber-physical systems, in the same as voice-activated digital assistants (such Siri/Viv, Cortana, Google and Alexa).

(b) AP based intelligent fog agent for real-time security intelligence. With storage and computing capabilities, an AP based fog agent will be capable of video, audio, and data analytics at the network edge, so enterprises gain real-time security intelligence, including event processing and classification. This, in turn, will help certain industries understand the data at their disposal, reducing maintenance costs, and improving efficiency.

(c) AP based intelligent fog agent for content distribution and media sharing. With mass storage, an AP based intelligent fog agent offers a natural expansion for IoT devices' memory, and can stream video and audio files wirelessly, and import or export images and videos to mobile devices. The availability of mass storage at an AP based intelligent fog agent at the network edge makes it possible to apply business rules and control which data remains in the fog for real-time analytics, and which is sent to the cloud for long-term storage and historical analysis. As a consequence, time-sensitive data is collected, stored, and analyzed locally, at an AP based fog agent, while less critical data is sent to the cloud for follow-up analysis, thereby forming a smooth continuum from the fog to the cloud. The availability of mass storage at an AP based fog agent will be useful for multiple industry verticals.

(d) AP based intelligent fog agent for P2P messaging and group messaging. In cruise lines and airlines industries, WiFi AP based information service and entertainment service are largely standard, and available to passengers. In some cases, messaging between passengers and the service provider are also enabled. However, P2P or group messaging is often clumsy and slow, and may even require an internet connection. With an AP based intelligent fog agent, P2P and group messaging service can be provided rapidly and elegantly, without the need for an internet connection.

(e) AP based intelligent fog agent for value-added service. In retail sectors, domain specific value added services can be made possible through AP based intelligent fog agents. For example, in a clothing store, customers walking into the store can be instantly connected to the intelligent fog agent and browse the catalog of the products available within the store or through the retailer's website. If the customer is interested in some items of clothing, instead of going to a fitting room, a smart mirror can overlay the items onto the customer's body using virtual reality or augmented reality (VR/AR) technologies and perform measurements to predict how well the items will fit the customer. This will not only result in a better customer experience, but also allow the merchant to collect customer data for analytics.

The features of the present invention which are believed to be novel are set forth below with particularity in the appended claims. Although the invention and its advantages have been described herein, it should be understood that various changes, substitutions and alterations can be made without departing from the spirit and scope of the claims. Moreover, the scope of the application is not intended to be limited to the particular embodiments described in the specification. As one of ordinary skill in the art will readily appreciate from the disclosure, alternatives presently existing or developed later, which perform substantially the same function or achieve substantially the same result as the corresponding embodiments described herein, may be utilized. Accordingly, the appended claims are intended to include within their scope such alternatives and equivalents.

What is claimed is:

1. A fog network comprising:
a fog network device, the fog network device comprising:
a processor;
a memory, the memory comprising non-transitory computer-readable media, the memory coupled to the processor;
a local area network (LAN) interface coupled to the processor;
a data analytics logic module residing in the memory; and
a fog network management logic module residing in the memory, wherein the logic modules are executable by the processor.

2. The fog network device of claim 1 wherein the fog network device comprises an access point (AP) based intelligent fog agent.

3. The fog network device of claim 1 further comprising:
a wide area network (WAN) interface coupled to the processor.

4. The fog network device of claim 3 wherein the WAN interface comprises a cellular interface.

5. The fog network device of claim 1 wherein the LAN interface comprises a WiFi interface.

6. The fog network device of claim 1 wherein the LAN interface comprises a WiFi-Direct interface.

7. The fog network device of claim 1 wherein the LAN interface comprises a Bluetooth interface.

8. The fog network device of claim 1 further comprising:
a messaging gateway logic module residing in the memory.

9. The fog network device of claim 1 further comprising:
an artificial intelligence (AI) or machine learning logic module residing in the memory

10. The fog network device of claim 1 further comprising at least one logic module residing in the memory and selected from the list consisting of:
AP-to-AP communication, firewall, database, and web server.

11. The fog network of claim 1 further comprising:
a data classifier operable to classify at least a portion of data on the fog network according to at least one criteria selected from the list consisting of:
processing urgency requirement, processing burden, and storage requirement.

12. The fog network of claim 1 wherein the fog agent comprises the data classifier.

13. The fog network of claim 1 further comprising:
a video analytics engine operable to analyze video data on the fog network for alert conditions.

14. The fog network of claim 13 further comprising:
an alarm condition processor coupled to the video analytics engine, the alarm condition processor operable to issue an alarm in response to an alarm condition.

15. The fog network of claim 14 wherein the fog agent comprises at least one of the video analytics engine and the alarm condition processor.

16. A computer-implemented method of operating a fog network, the method executable by a processor, the method comprising:
receiving data over a local area network (LAN) interface by a fog agent;
storing the received data in a memory local to the fog agent;
analyzing the data according to processing or storage requirements; and
responsive to the analyzing retaining the data within the fog network or sending the data to a remote node through a wide area network (WAN) interface.

17. The method of claim 16 wherein sending the data to a remote node comprises sending the data to a remote cloud node for processing or storage.

18. The method of claim 16 wherein sending the data to a remote node comprises sending video data to a monitoring center.

19. The method of claim 16 wherein analyzing the data comprises analyzing the data for an alarm condition.

20. The method of claim 16 wherein analyzing the data comprises analyzing the data for a back-up or archival requirement.
